(19) United States
(12) Patent Application Publication
(10) Pub. No.: US 2010/0019529 A1
(43) Pub. Date: Jan. 28, 2010

(54) Truck Bed Cover and Method

(76) Inventor: Travis Alston, Huntsville, AL (US)

Correspondence Address: LANIER FORD SHAVER & PAYNE P.C., P O BOX 2087, HUNTSVILLE, AL, 35804-2087, US

(21) Appl. No.: 12/179,149

(22) Filed: Jul. 24, 2008

(51) Int. Cl. B60P 7/02

(52) U.S. Cl. 296/100.09

(57) ABSTRACT

A truck bed cover has one or more foldable sections for covering a bed of a truck. In addition, the truck bed cover has one or more flaps attached to the sections, and each of the flaps has a magnet for magnetically coupling the sections to the truck.

### BACKGROUND OF THE INVENTION

Trucks oftentimes have truck beds suitable for carrying cargo. The truck bed is typically an open-ended container in which the cargo is placed. The truck bed can be accessed more readily through use of a tail gate that opens so that cargo can be more easily placed within the truck bed.

### SUMMARY OF THE INVENTION

An exemplary truck bed cover in accordance with an embodiment of the present disclosure comprises one or more foldable sections for covering a bed of a truck. In addition the truck bed cover comprises one or more flaps attached to the sections, each of the flaps comprising a magnet for magnetically coupling the sections to the truck.

An exemplary truck bed cover in accordance with another embodiment of the present disclosure comprises a panel for covering the opening in a bed of a truck, the panel comprising a front side for situating adjacent a tailgate of a truck, a back side for situating adjacent a cab of the truck, and two sides for situating adjacent a first and second side of the truck. In addition, the truck bed cover comprises a plurality of flaps, at least three of the flaps comprising magnets and coupled to the panel at the front side and the back side such that the flaps magnetically couple the panel to the truck.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the invention. Furthermore, like reference numerals designate corresponding parts throughout the figures.

FIG. 1 is a perspective view of truck and an exemplary truck bed cover in accordance with an embodiment of the present disclosure.

FIG. 2 is a top plan view of the truck bed cover of FIG. 1.

FIG. 3 is a side plan view of the truck bed cover of FIG. 1.

FIG. 4 is a side plan view of the truck and the truck bed cover of FIG. 1.

FIG. 5 is a rear plan view of the truck and the truck bed cover of FIG. 1.

### DETAILED DESCRIPTION OF THE INVENTION

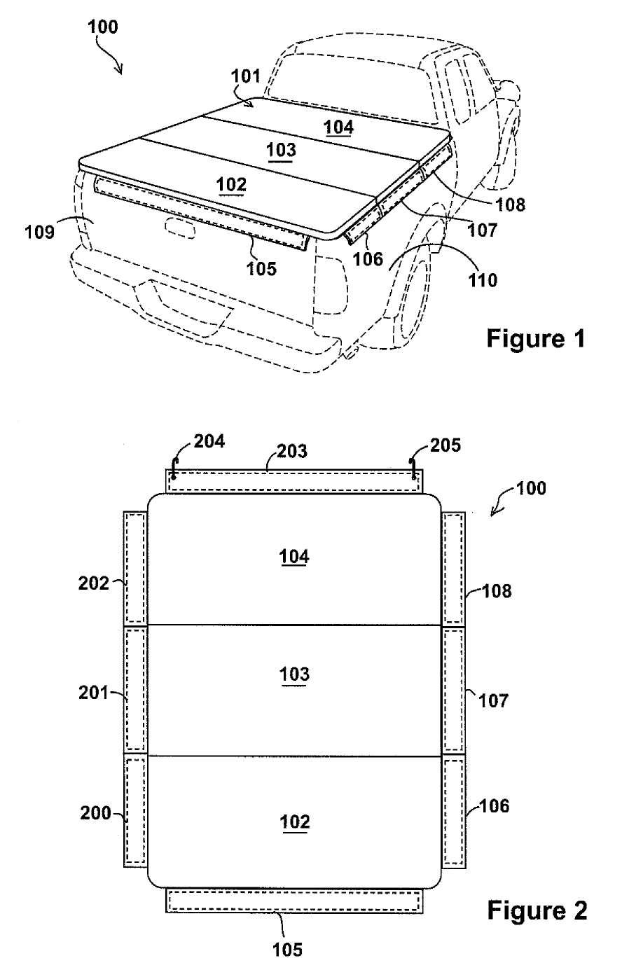

FIG. 1 is a perspective view of a truck 100 and an exemplary truck bed cover 101 coupled to the truck 100 in accordance with an embodiment of the present disclosure. The truck bed cover 101, when coupled to the truck 100, ensures that cargo (not shown) within the truck 100 is protected from the elements and remains within the truck 100.

The truck bed cover 101 comprises one or more sections 102-104. As described further herein, these sections 102-104 may be lifted by section 102-104 in order to allow access to any cargo within the truck 100.

Furthermore, the truck bed cover 101 comprises one or more flaps 105-108. The flaps coupled to the truck 100 magnetically. In this regard, flap 105 magnetically couples to a tailgate 109 of the truck 100. In addition, the flaps 106-108 magnetically coupled to a side 110 of the truck 100.

In one embodiment, the truck bed cover 101 is made of a water impermeable material. For example, the truck bed cover 101 is made of a plastic/vinyl material that protects cargo within the truck 100 from the elements, including rain. However, the truck bed cover 101 may be made of any other type of material known in the art or future-developed.

FIG. 2 is a top plan view of the truck bed cover 101 depicted in FIG. 1. As noted herein, the truck bed cover 101 comprises the sections 102-104. Section 102 is attached to adjacent section 103, and section 104 is attached to adjacent section 103. In addition, sections 102 and 103 may be lifted thereby exposing cargo within the truck 100 (FIG. 1), which is described further herein.

Further, as noted herein, the truck bed cover 101 comprises the flaps 105-108. In addition, as seen from the top plan view of FIG. 2, the truck bed cover comprises additional flaps 200-203. The flap 105 magnetically couples to the tailgate 109 (FIG. 1) while the flaps 106-108 and 200-202 magnetically couple to the sides of the truck 100 (FIG. 1). Each of the flaps 105-108 and 200-203 are attached to the sides of the sections 102-104.

The flap 203 coupled to section 104 comprises one or more connecting devices 204 and 205. Theses connection devices 204 and 205 may be hooks, for example. The connection devices couple to the truck 100 to retain the truck bed cover 101 on the truck 100.

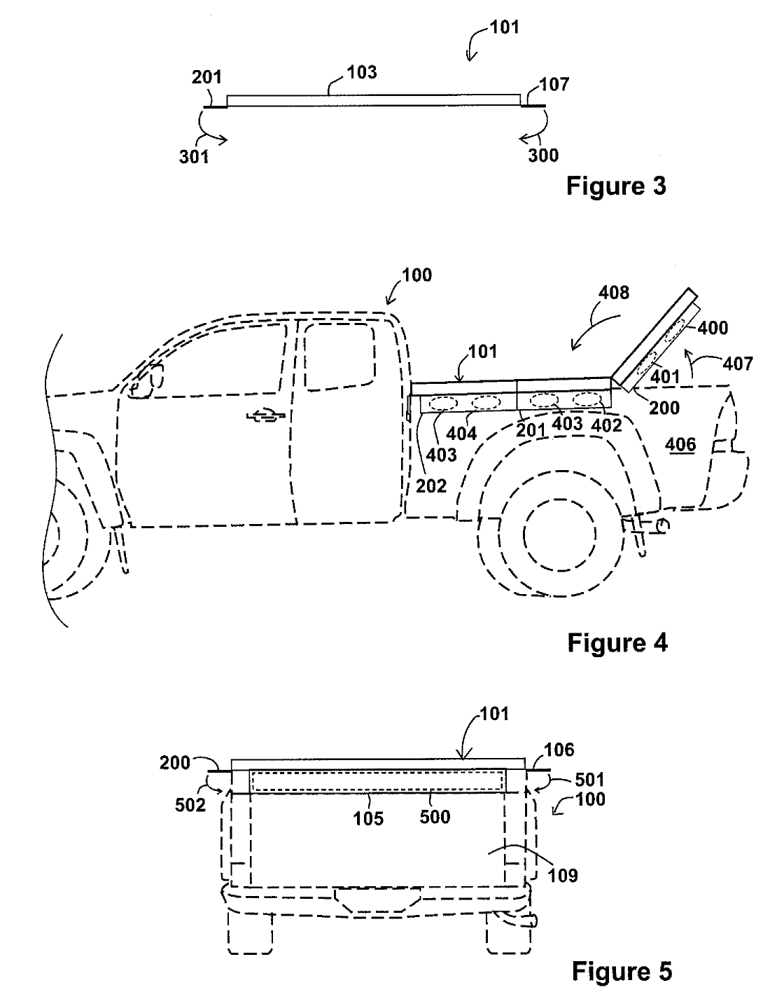

FIG. 3 depicts a cross-sectional view of the truck bed cover 101. The cross-sectional view is of section 103, which is attached to the flaps 107 and 201. Reference arrows 300 and 301 depict movement of the flaps 107 and 201. Notably, when the truck bed cover 101 is placed on the truck 100, the flaps 107 and 201 move in the direction of reference arrows 300 and 301, and the flaps 107 and 201 magnetically couple to the sides of the truck 100 (FIG. 1).

FIG. 4 depicts a side plan view of the truck 100 and the truck bed cover 101. Note that FIG. 4 only depicts one side 406 of the truck 100, and FIG. 4 only depicts the flaps 200-202 of the truck bed cover 101. However, the opposite side 110 of the truck 100 depicted in FIG. 1 is substantially similar to the side 406, and the flaps 106-108 depicted in FIG. 1 are substantially similar to the flaps 200-202. Therefore, only one side 406 is described further for brevity.

Each of the flaps 200-202 are coupled to one or more magnets 400-405. The magnets 400-405 may be sewn within fabric of the flaps 200-201 in one embodiment. In another embodiment, the magnets 400-405 may be coupled to the flaps 200-201 via an epoxy material (not shown). Thus, when the truck bed cover 101 is laid on the truck 100, the magnets 400-405 couple to the side 406 of the truck 100 thereby securing the truck bed cover 101 to the truck 100.

In addition, the sections 102 and 103 may lift thereby providing access to cargo (not shown) within the truck 100. FIG. 4 depicts the front section 102 as it is lifted as described. Notably, the section 102 is lifted by a user (not shown) in a direction indicated by reference arrows 407 and 408 until the section 102 rests on top of the section 103. Thus, the user has access to cargo within the truck 100 without having to remove the entire truck bed cover 101.

FIG. 5 depicts an end plan view of the truck 100 and the truck bed cover 101. In this regard, the flap 105 further comprises at least one magnet 500. The magnet 400 may be sewn within fabric of the flap 500 in one embodiment. In another embodiment, the magnet 500 may be coupled to the flap 105 via an epoxy material (not shown). Thus, when the truck bed cover 101 is laid on the truck 100, the magnet 500 couples to the tailgate 109 of the truck 100 thereby securing the truck bed cover 101 to the truck 100.

Now, therefore, the following is claimed:

1. A truck bed cover, comprising:
one or more foldable sections for covering a bed of a truck; and
one or more flaps attached to the sections, each of the flaps comprising a magnet for magnetically coupling the sections to the truck.

2. The truck bed cover of claim 1, wherein at least one flap comprises a connection device for connecting to the truck.

3. The truck bed cover of claim 2, wherein the connection device is a hook.

4. The truck bed cover of claim 1, wherein the magnets are sewn within the one or more flaps.

5. The truck bed cover of claim 1, wherein the magnets are attached to the one or more flaps via an epoxy material.

6. The truck bed cover of claim 1, wherein at least one of the flaps magnetically couples to a tailgate of the truck.

7. The truck bed cover of claim 5, wherein at least two of the flaps magnetically couples one or more of the sections to one or more sides of the truck.

8. A truck bed cover, comprising:
a panel for covering the opening in a bed of a truck, the panel comprising a front side for situating adjacent a tailgate of a truck, a back side for situating adjacent a cab of the truck, and two sides for situating adjacent a first and second side of the truck; and
a plurality of flaps, at least three of the flaps comprising magnets and coupled to the panel at the front side and the back side such that the flaps magnetically couple the panel to the truck.

9. The truck bed cover of claim 1, wherein at least one flap is coupled to the back side.

10. The truck bed cover of claim 9, wherein the at least one flap coupled to the back side comprises a connection device for connecting to the truck.

11. The truck bed cover of claim 10, wherein the connection device is a hook.

12. The truck bed cover of claim 8, wherein the magnets are sewn within the at least three flaps.

13. The truck bed cover of claim 8, wherein the magnets are attached to the flaps via an epoxy material.

14. The truck bed cover of claim 8, wherein the panel comprises at least two sections.

15. The truck bed cover of claim 14, wherein one of the two sections is foldable.

16. The truck bed cover of claim 15, wherein the foldable sections is folded up onto the second section so that a user can access cargo within the truck.

17. A truck bed cover, comprising:
a panel for covering the opening in a bed of a truck; and
means for magnetically coupling the panel to the truck.
